(19) United States
(12) Patent Application Publication
(10) Pub. No.: US 2026/0180219 A1
(43) Pub. Date: Jun. 25, 2026

(54) CABLE ASSEMBLY AND CABLE BYPASS ASSEMBLY HAVING THE SAME

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: TERRANCE F. LITTLE, Fullerton, CA (US)

(21) Appl. No.: 18/989,779

(22) Filed: Dec. 20, 2024

(51) Int. Cl. H01R 12/77; H01R 13/502; H01R 13/652; H01R 13/6585; H01R 107/00

(52) U.S. Cl. CPC H01R 12/775; H01R 13/652; H01R 13/6585; H01R 13/502; H01R 2107/00

(57) ABSTRACT

A cable assembly includes: a row of terminals including plural contact portions and tail portions, the row of terminals including plural pairs of signal terminals; an insulator secured to the row of terminals; an upper shielding plate and a lower shielding plate surrounding the row of terminals, at least one of the upper shielding plate and the lower shielding plate integrally having plural ground contact portions aligned with the contact portions of the row of terminals; and a cable comprising a pair of signal conductors, an insulative layer enclosing the pair of signal conductors, and a ground shield disposed outside the insulative layer, the pair of signal conductors electrically connected to the tail portions of a corresponding pair of signal terminals, the ground shield electrically connected to at least one of the upper shielding plate and the lower shielding plate.

### BACKGROUND OF THE INVENTION

### Field of the Invention

The present invention relates generally to a cable bypass assembly, and more particularly to a cable bypass assembly used to transmit high frequency signals.

### Description of Related Arts

U.S. Pat. No. 10,680,364 discloses a communication system including a host circuit board having a cage member defining a module cavity, a receptacle assembly mounted to the host circuit board, and a pluggable module having a pluggable body loaded into the module cavity. The pluggable body has a mating interface along a bottom of the pluggable body facing the host circuit board. The pluggable module has a cable assembly having a cable and a cable connector at an end of the cable including signal contacts held by a contact holder that are terminated to signal conductors of the cable. The signal contacts have deflectable spring beams and mating interfaces along the deflectable spring beams exposed at the mating interface of the pluggable body to engage and directly mate with corresponding signal pads of the host circuit board. Crosstalk easily forms between cable components and is not suitable for high-speed signal transmission.

### SUMMARY OF THE INVENTION

A main object of the present invention is to provide a cable bypass assembly having a good electrical performance.

To achieve the above object, a cable bypass assembly adapted for mating with a mating connector that is inserted into a device for electrically connecting the mating connector to a vicinity of a chip of the device, the cable bypass assembly comprising: a connector housing; a first cable assembly received in the connector housing; and a second cable assembly received in the connector housing and disposed opposite to the first cable assembly to form a mating area for mating with the mating connector, each of the first cable assembly and the second cable assembly including: a plurality of pairs of signal terminals arranged in a row, each signal terminal including a signal contact portion and a signal tail portion; an upper shielding plate disposed on an upper side of the row of signal terminals; a lower shielding plate disposed on a lower side of the row of signal terminals, at least one of the upper shielding plate and the lower shielding plate integrally having a plurality of ground contact portions aligned with the signal contact portions of the plurality of pairs of signal terminals; and a plurality of cables each comprising a pair of signal conductors, an insulative layer enclosing the pair of signal conductors, and a ground shield disposed outside the insulative layer, the ground shield and the signal conductors having opposed first and second free ends, the first free end of the signal conductors being electrically connected to the signal tail portions of a pairs of signal terminals, the first free end of the ground shield being electrically connected to at least one of the first shielding plate and the second shielding plate, and the second free ends of the ground shield and the signal conductors being electrically coupled to a vicinity of the chip within the device..

Compared to prior art, the cable bypass assembly comprises a metal shielding plate disposed on one side of a row of terminals, so that the cable bypass assembly has better electrical performance for transmitting high speed signal.

### BRIEF DESCRIPTION OF DRAWINGS

FIG. 1 is a perspective view a cable bypass assembly according to the first embodiment of present invention;

FIG. 2 is another perspective view of the cable bypass assembly of FIG. 1;

FIG. 3 is a partly exploded view of the cable bypass assembly of FIG. 1;

FIG. 4 is a further exploded view of the cable bypass assembly of FIG. 3;

FIG. 5 is a further exploded view of the cable bypass assembly of FIG. 4;

FIG. 6 is another exploded view of the cable bypass assembly of FIG. 5;

FIG. 7 is an exploded view of the cable bypass assembly of FIG. 5; with the insulative housing being removed;

FIG. 8 is another exploded view of the cable bypass assembly of FIG. 7;

FIG. 9 is an exploded view of the upper cable assembly of the cable bypass assembly of FIG. 7;

FIG. 10 is another exploded view of the upper cable assembly of FIG. 9;

FIG. 11 is another exploded view of the upper cable assembly of the cable bypass assembly of FIG. 7;

FIG. 12 is a perspective view of the row of terminal, upper shielding plate, the lower shielding plate of the upper cable assembly of the upper cable assembly FIG. 7;

FIG. 13 is another perspective view of the row of terminal, upper shielding plate, the lower shielding plate of the upper cable assembly of the upper cable assembly FIG. 12;

FIG. 14 is a side view of the upper cable assembly of FIG. 7;

FIG. 15 is a cross-sectional view of the cable bypass assembly taken along line A-A in FIG. 1;

FIG. 16 is a perspective view of a second embodiment of the upper cable assembly;

FIG. 17 is an exploded view of an upper upper cable assembly of FIG. 16; and

FIG. 18 is a side view of the upper cable assembly of FIG. 16.

### DETAILED DESCRIPTION OF THE DRAWINGS

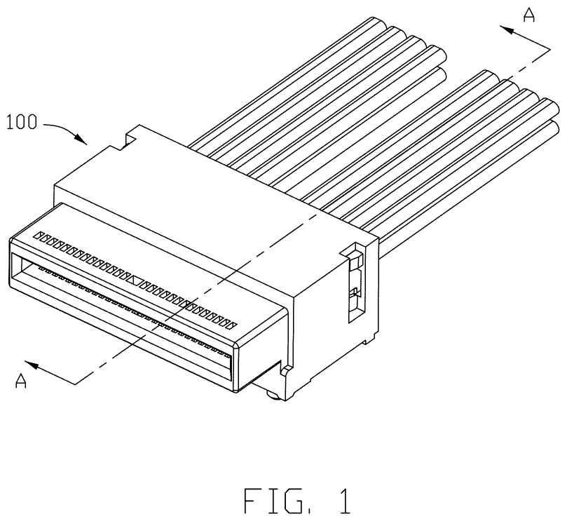

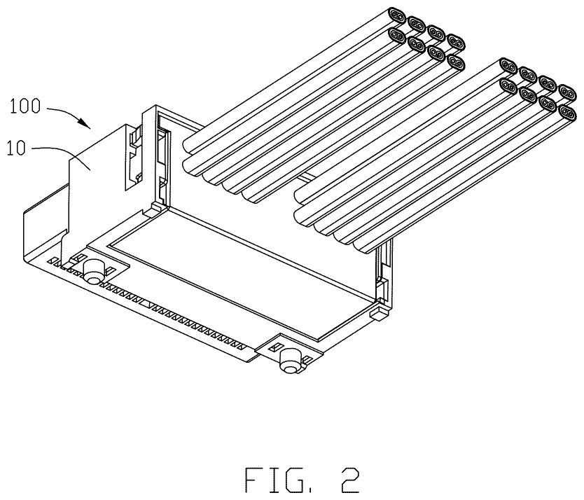

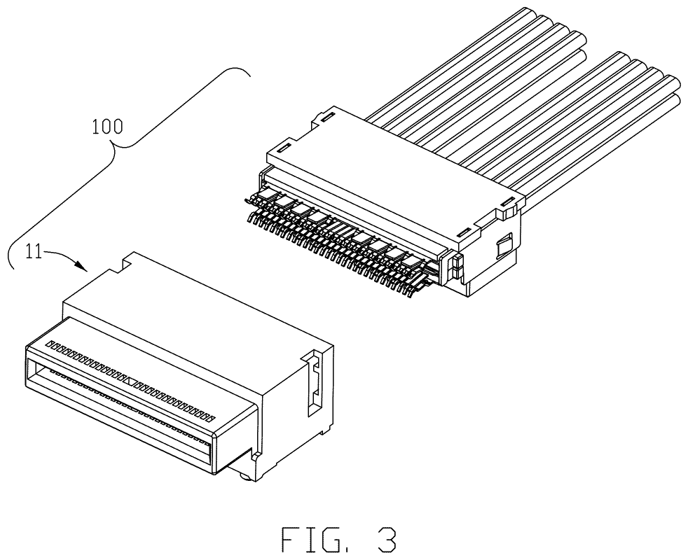

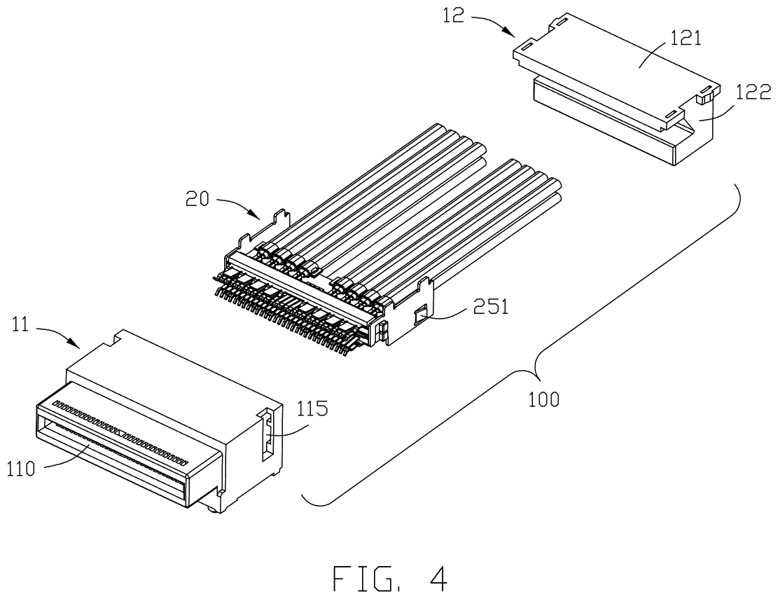

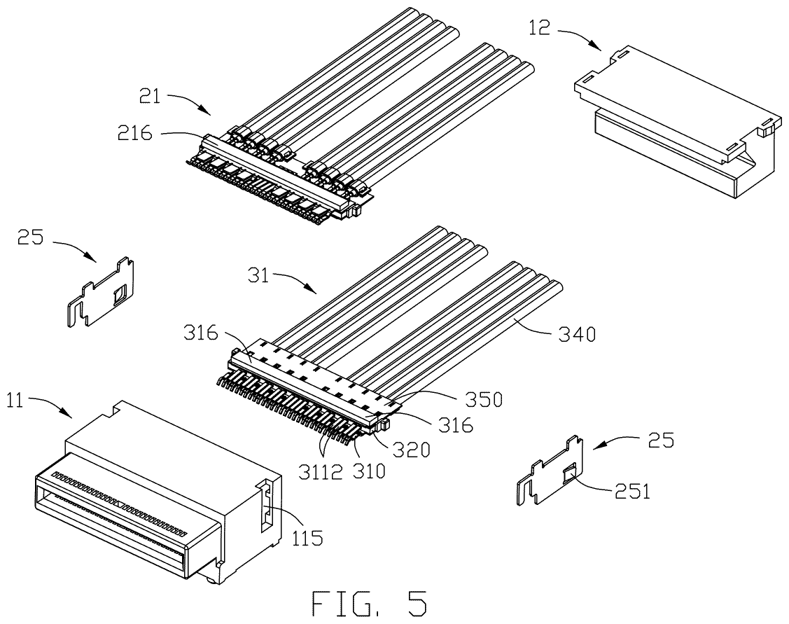

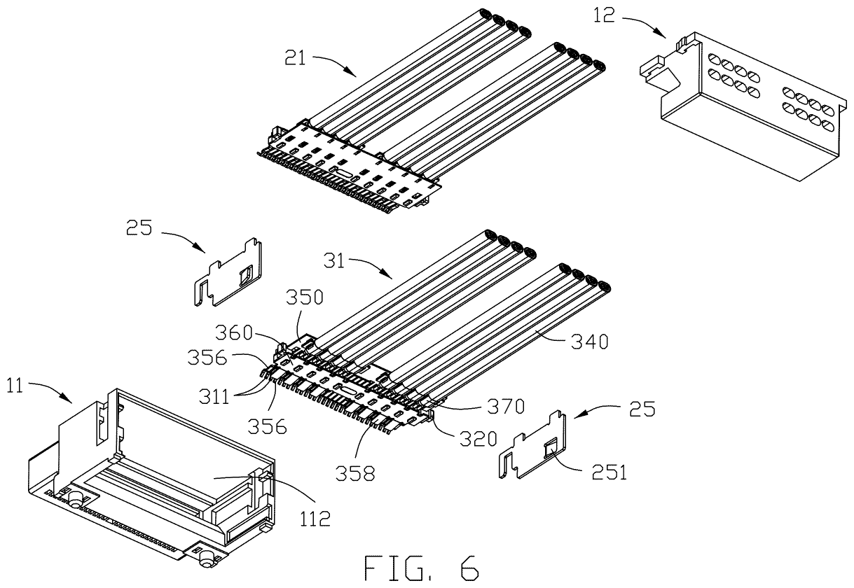

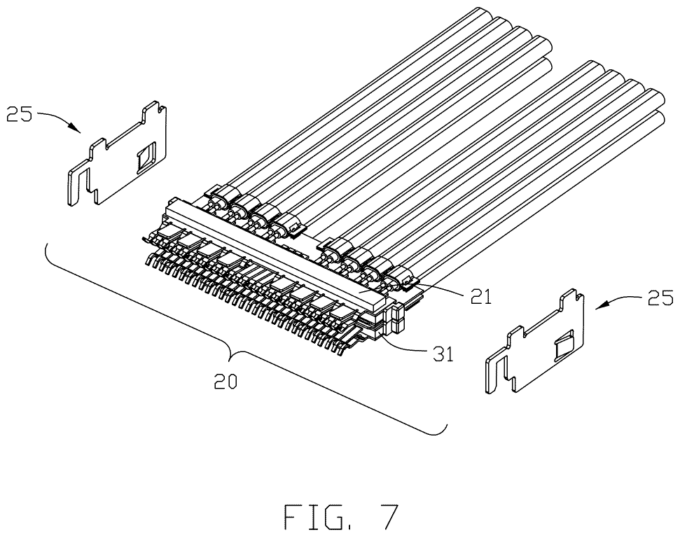

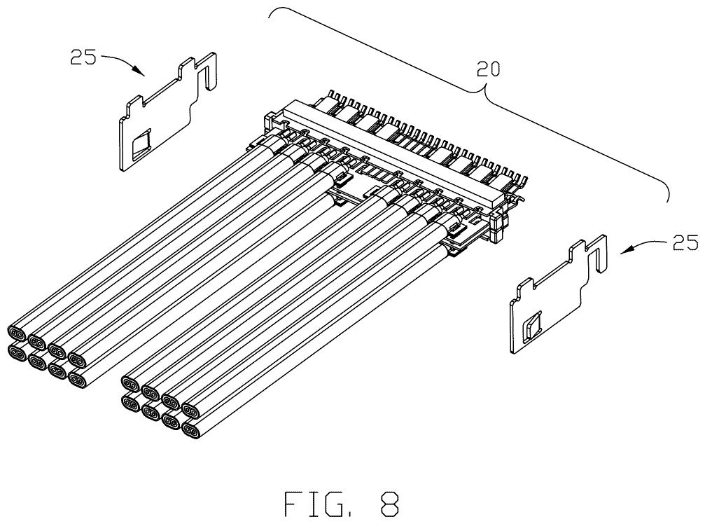

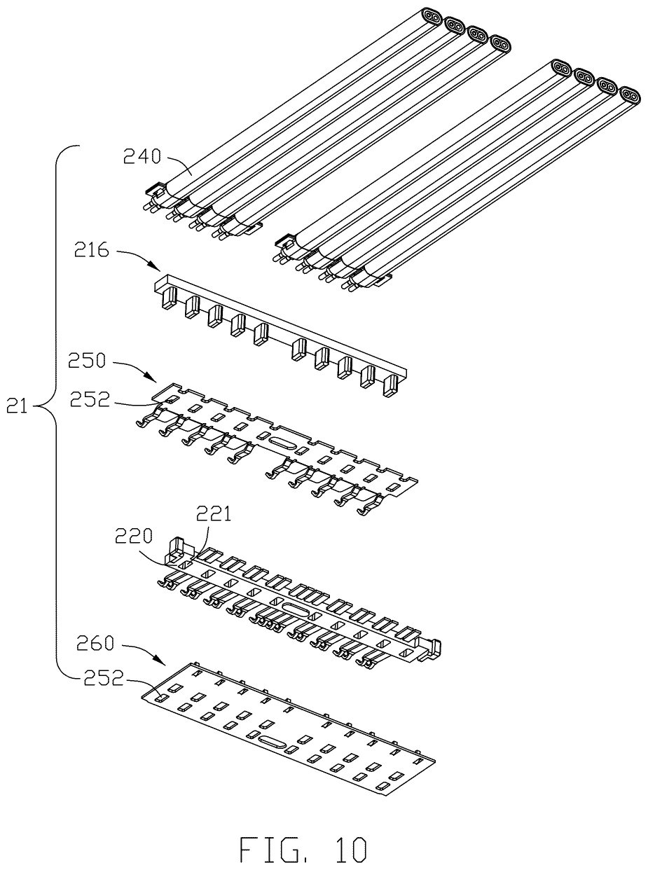

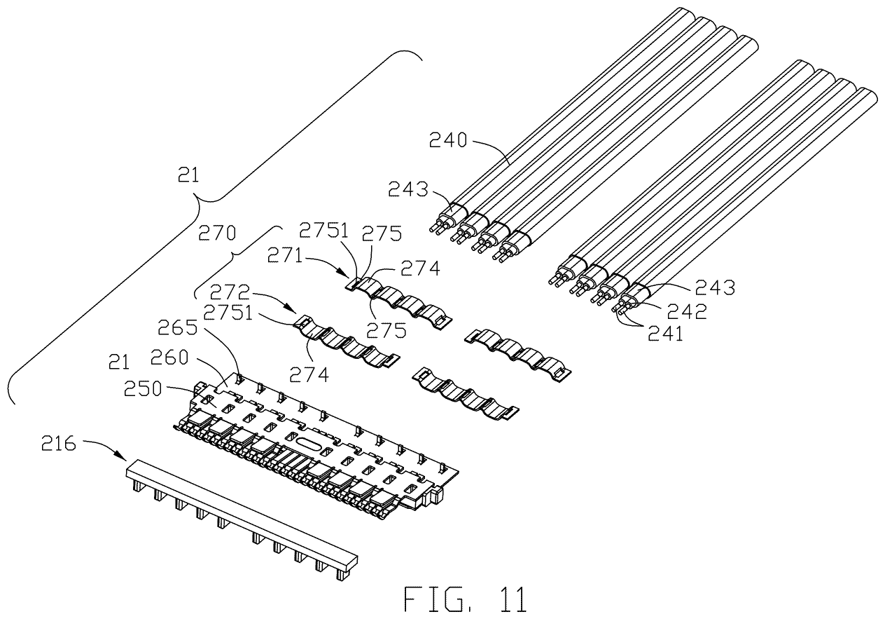

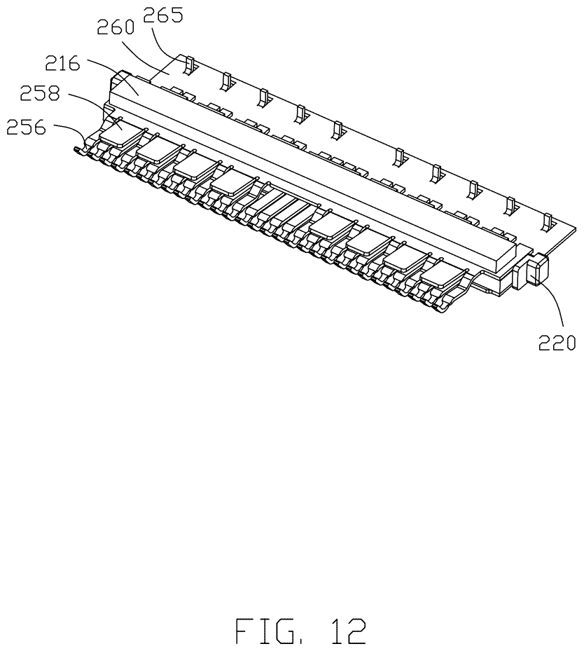

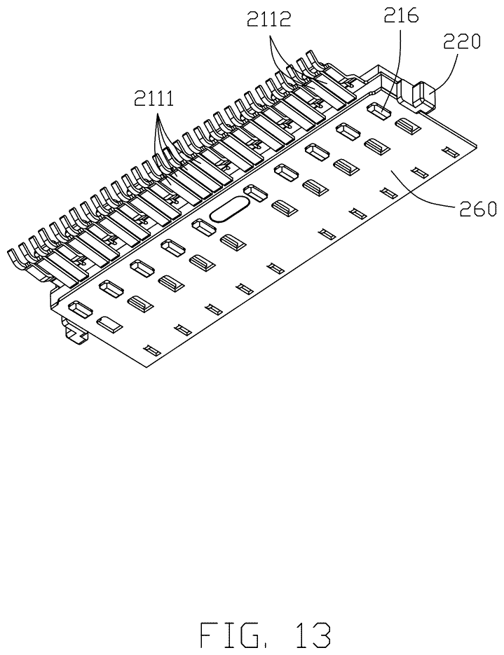

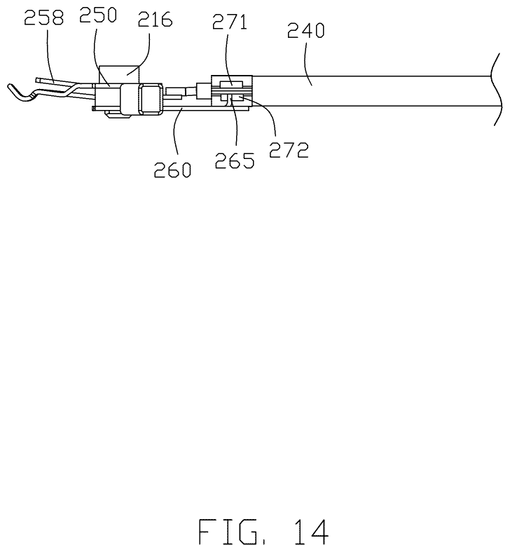

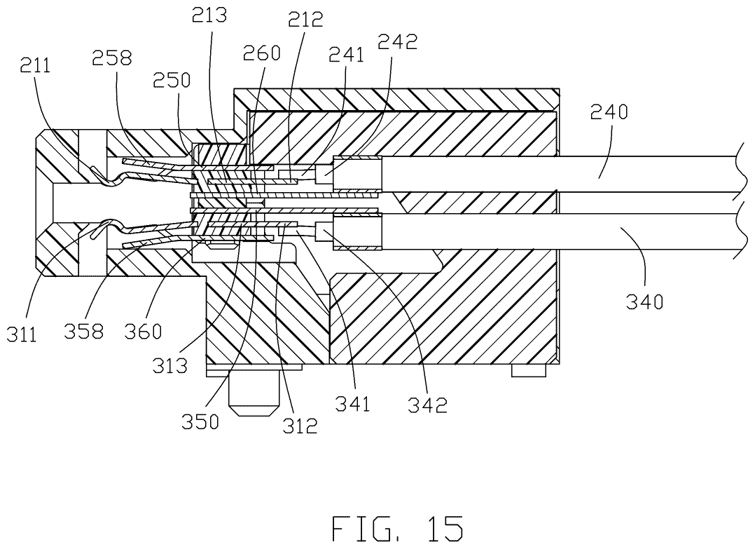

Referring to FIGS. 1-15, a cable bypass assembly 100 of the present invention is shown. The cable bypass assembly 100 is adapted to be mounted on a printed circuit board of a device and and mate or connect with a mating connector that is inserted into the device and can electrically connect the mating connector to a vicinity of a chip of the device. The cable bypass assembly 100 comprises a connector housing 10 formed by insulative material adapted for mating with the mating connector, and a cable assembly 20 received in the connector housing 10.

The connector housing 10 includes a main body 11 and a cover 12. The main body 11 includes a front mating slot 110 provided on the front side for mating with the mating connector and an installation opening 112 located on the rear side. The cover 12 has a top portion 121 and a rear portion 122.

The cable assembly 20 includes a upper cable assembly or a first cable assembly 21, a lower cable assembly or second cable assembly 31 disposed in an up-down direction with the first cable assembly 21, and a pair of metal side plates 25 for assembling the first cable assembly 21 and the second cable assembly 31. The front areas of the first cable assembly 21 and the second cable assembly 31 together form a mating area for mating with a mating tongue of the mating connector. The metal side plate 25 holds the first cable assembly 21, the second cable assembly 31, and the cover 12 together to be assembled to the main body 11. The metal side plate 25 has an elastic piece 251 protruding outward, and the connector housing 10 has an opening 115 that cooperates with the elastic piece 251.

The structure of the second cable assembly 31 is similar to that of the first cable assembly 21, the main difference is that the second cable assembly 31 and the first cable assembly 21 are symmetrically arranged in the up-down direction. Taking the first cable assembly 21 as an example for detailed introduction. The first cable assembly 21 includes a first row of terminals 210 arranged in a transverse direction perpendicular to the up-down direction, a first insulator 220 secured the first row of terminals 210, a plurality of cables 240 electrically connected to at least some of the terminals in the first row of terminals 210, an upper shielding plate 250 and a lower shielding plate 260 that surround the first row of terminals 210, and a conductive element 216 electrically connecting the upper and lower shielding plates 250 and 260.

Each of the first row of terminals 210 has a contact portion 211, a tail portion 212, and a connecting portion 213 therebetween. The first insulator 220 is integrally formed on the connecting portion 213 of the first row of terminals 210 via insert molding. The first row of terminals 210 includes a plurality of pairs of signal terminals 2112 for transmitting high-speed signals and a plurality of sideband terminals 2111 for transmitting low-speed signals, power, control, etc. In the present invention, the first row of terminals 210 includes four sideband terminals 2111 and eight pairs of signal terminals 2112. The sideband terminal 2111 is in the middle area, and the eight pairs of signal terminals 2112 are evenly divided into two groups and are arranged on two sides of the sideband terminal 2111. Of course, the number of high-speed signal can be any number greater than or equal to one. The number of low-speed signals, power supply, control and other signal channels can also be increased or decreased, or even not provided.

Neither the upper shielding plate 250 nor the lower shielding plate 260 is electrically connected to the first row of terminals 210. The upper shielding plate 250 and the lower shielding plate 260 are spaced apart from the first row of terminals 210 through the first insulator 220.

The upper shielding plate 250 is spaced a first distance from the first row of terminals 210, and the lower shielding plate 260 is spaced a second distance from the first row of terminals 210. The first distance is equal to the second distance. The upper ground plate 250 and the lower ground plate 260 equidistantly spaced from and surround the connecting portions of first row of terminals 210 to form a strip-line structure for achieving a better high speed transmission performance, like a PCB style design.

Each of the upper shielding plate 250 and the lower shielding plate 260 is generally planar and be a single piece. To have a better shielding effect, the upper shielding plate 250 and the lower shielding plate 262 in the lateral direction is greater than or equal to the outermost dimension of the first row of contacts 210 in the lateral direction.

Each of the cable 240 includes a pair of signal conductors 241, an insulative layer 242 covering the pair of signal conductors 241, and a ground shield 243 disposed outside the insulative layer 242. In this embodiment, the ground shield 243 is a shielding layer covering the insulative layer 242, and each of the cables 22 is devoid of drain wire. Of course, in other embodiments, the ground shield 243 may also be a drain wire. The ground shield 243 and the signal conductors 241 have opposite first free ends and second free ends. The first free end of the signal conductors 241 are terminated to the tail portions 212 of signal terminals 2112, and the first free end of the ground shield 243 is electrically connected to at least one of the upper shielding plate 250 and the lower shielding plate 260. The second free end of the signal conductor 241 and the ground shield 243 being electrically coupled to the vicinity of the chip within the device.

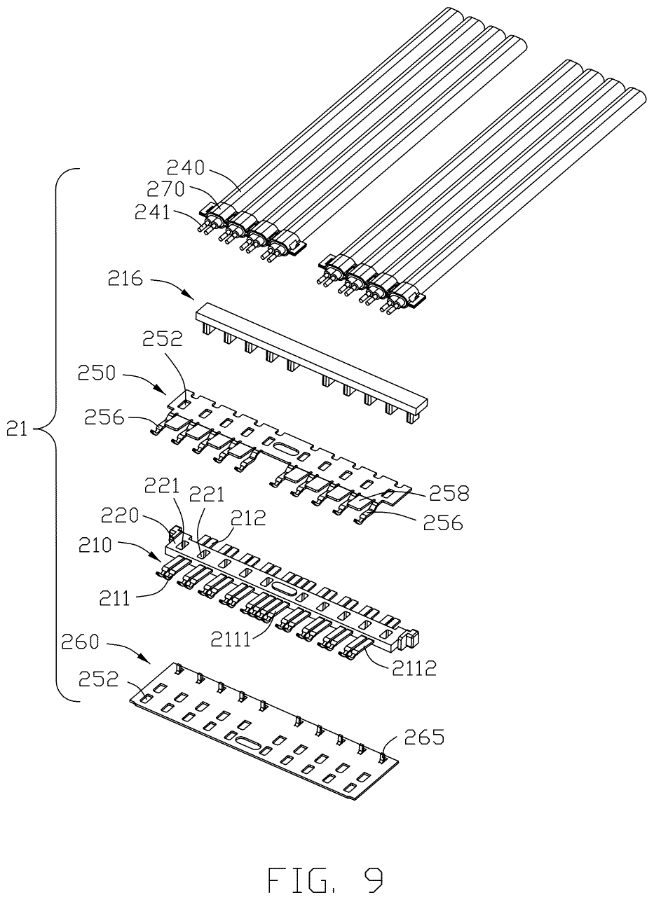

Referring specifically to FIGS. 9-11, the upper shielding plate 250 integrally forms a plurality of ground contact portions 256. As can be understood, the plurality of ground contact portions may equally well be formed on the lower shielding plate 260, or the upper shielding plate 250 may form some of the plurality of ground contact portions while the lower shielding plate 260 form the remaining ground contact portions. The ground contact portion 256 and the contact portion 211 of the first row of terminals 210 are arranged in a row along a transverse direction and are located on the upper side of the front mating groove 110. The contact portions 211 of each pair of signal terminals 2112 are located between two adjacent ground contact portions 256. The lower shielding plate 260 integrally forms a plurality of ground tails 265 electrically connected to the ground shield 243. As can be understood, the plurality of ground tails may equally well be formed on the upper shielding plate 250. The ground tail 265 is a sheet-like structure integrally stamped from the lower shielding plate 260.

The tail portion 212 of the signal terminal 2112 extends backward beyond the rear end of the upper shielding plate 250 to facilitate contact with the signal conductor 241. The lower shielding plate 260 extends backward beyond the tail portion 212 of the signal terminal 2112 to facilitate the electrical connection with the ground shield 243.

The upper shielding plate 250 may further includes an overhanging feature for impedance control, such as front extensions 258 each situated between each every two ground contact portions 256. Each of the front extension 258 is cantilevered above a corresponding pair of signal terminals 2112, and the contact portions 211 of the pair of signal terminals 2112 extend forward beyond the frontmost end of the front extension 258.

The first cable assembly 21 further comprises a shielding member 270 placed on the lower shielding plate 260. Specifically, The shielding member 270 includes an upper half 271 and a lower half 272 arranged symmetrically with the upper half 271. Each of the upper half 271 and the lower half 272 include a raised portion 274 and straight portions 275 connected to two opposite sides of the raised portion 274. The raised portions 274 of the upper half 271 and the lower half 272 cooperate with each other to form a receiving portion that circumferential surrounds the exposed shielding layer of the cable 240 and connected to the shielding layer. The straight portions 275 of the upper half 271 and the lower half 272 have hole 2751 aligned with each other. The ground tail 265 extends upward into the holes 2751.

The conductive element 216 may be made of metal or other conductive materials. The conductive element 216 may be separately made and then assembled to the upper shielding plate 250 and the lower shielding plate 260, or the conductive element 216 may be formed in situ, e.g., molded from conductive plastic material. In the present invention, the conductive member 216 is made of conductive plastic material.

Specifically, The first insulator 220 has holes 221, and the upper and lower shielding plate 250 and 260 have holes 252 aligned with the holes 221. The conductive element 216 is integrally formed and extends through the holes 252 of upper shielding plate 250, the holes 221 of the first insulator 220, and the holes 252 of the lower shielding plate 260. The first insulator 220 is provided with a hole 221 between each adjacent pair of signal terminals 2112.

In the first cable assembly 21, the shield member 270, the ground shield 243 of the cable 240, the upper shielding plate 250, the lower shielding plate 260 and the conductive element 216 are electrically connected in series form a common ground, which has a better grounding effect, moves crosstalk to a higher frequency, and reduces crosstalk within the operating frequency, improve the signal transmission performance of the first cable assembly 21.

The second cable assembly 31 includes a second row of terminals 310 arranged in a transverse direction, a second insulator 320 secured the second row of terminals 310, a plurality of second cable 340 electrically connected to the second row of terminals 310, an upper shielding plate 350 and a lower shielding plate 360 that surround the second row of terminals 310, and a conductive element 316 electrically connecting the upper and lower shielding plates 350 and 360.

Each of the second row of terminals 310 has a contact portion 311, a tail portion 312, and a connecting portion 313 therebetween. The second row of terminals 310 includes a plurality of pairs of second signal terminals 3112 for transmitting high-speed signals. The lower shielding plate 360 integrally forms a plurality of ground contact portions 356 aligned with the contact portions 311 of the second row of terminals 310 in a transverse direction and are located on the lower side of the front mating slot 110. The contact portions 311 of each pair of second signal terminals 3112 are located between two adjacent second ground contact portions 356. The upper shielding plate 350 integrally forms a plurality of ground tails. Each of the second cable 340 includes a pair of second signal conductors 341, a second insulative layer 342 covering the the pair of second signal conductors 241, and a shielding layer disposed outside the second insulative layer 342. The second signal conductors 341 are terminated to to the tail portions 312 of the corresponding pair of second signal terminals 3112. The overhang feature 358 for impedance controlled of the second cable assembly 31 is formed on the lower shielding plate 360. The second cable assembly 31 further includes a second shielding member 370 that is in contact with the upper shielding plate 350.

The conductive member 216 of the first cable assembly 21 is in contact with that of the second cable assembly 31. The upper shielding plate 250 and the lower shielding plate 260 of the first cable assembly 21 and the upper shielding plate 350 and the lower shielding plate 360 of the second cable assembly 31 are electrically connected through the conductive members 216 and 316.

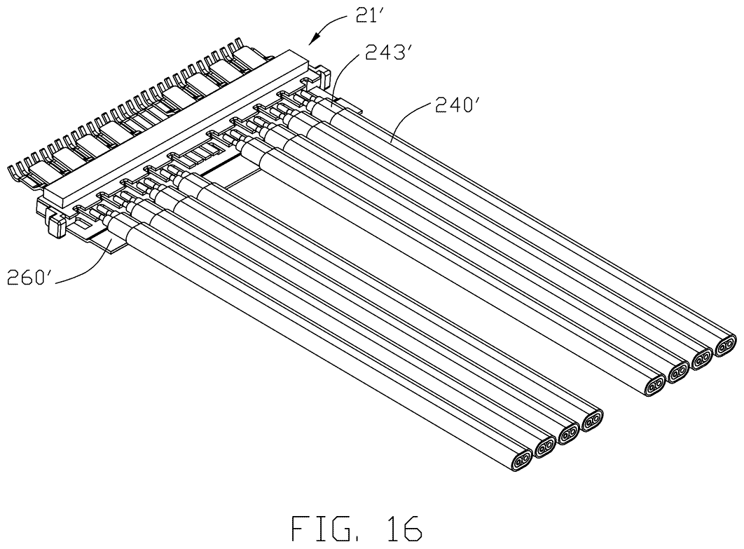

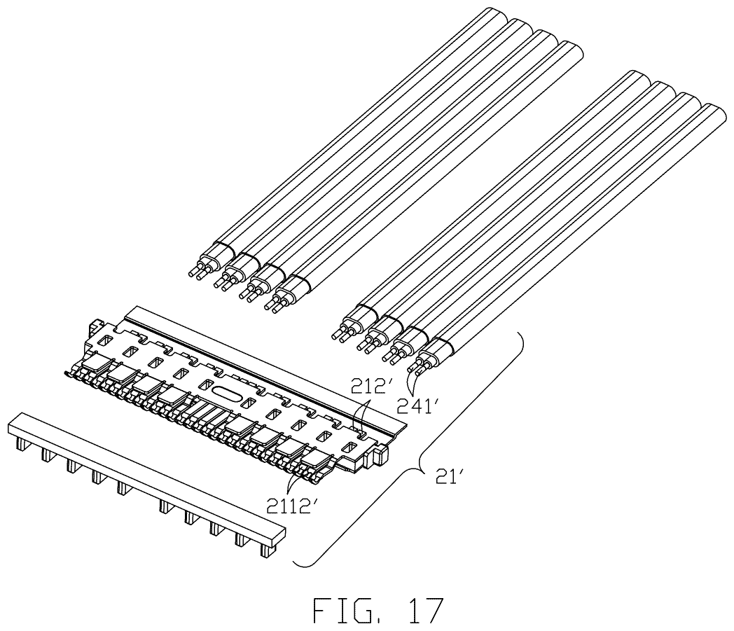

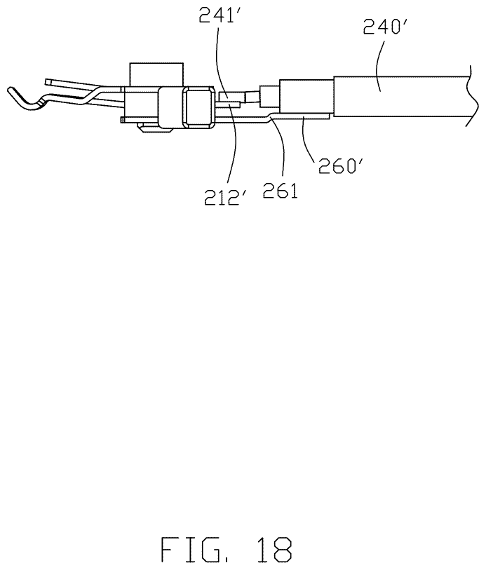

Referring to FIGS. 16-18, in a varied first cable assembly 21′, the shielding member 270 in the first embodiment is omitted, and the shielding layer 243′ of the cable 240′ is in direct contact with the lower shielding plate 260′. The rear portion of the lower shielding plate 260′ is bent upward to form a bent portion 261, in order to make the free end of the signal conductor 241′ directly contact with the tail portion 212′ of the signal terminal 2112′ devoid of bending.

The cable assembly of the present invention conforms to the specification of OSFP, which defines eight transmitting channels and eight receiving channels, the signal transmission rate of each channel can reach 50 Gbps or above. Of course, the present invention can also be applied to high-speed electrical connector assembly such as QSFP, QSFP DD, OSFP, OSFP XD, SFP, SFP DD, PCIe, MCIO, backplane connectors, etc.

1. A cable assembly comprising:
a row of terminals comprising a plurality of contact portions and a plurality of tail portions, the row of terminals comprising plural pairs of signal terminals for transmitting differential signals;
an insulator secured to the row of terminals;
an upper shielding plate and a lower shielding plate surrounding the row of terminals, at least one of the upper shielding plate and the lower shielding plate integrally having a plurality of ground contact portions aligned with the plurality of contact portions of the row of terminals, the contact portion of each of the plural pairs of signal terminals disposed between two adjacent ground contact portions; and
a cable comprising a pair of signal conductors, an insulative layer enclosing the pair of signal conductors, and a ground shield disposed outside the insulative layer, the pair of signal conductors electrically connected to the tail portions of a corresponding pair of signal terminals, the ground shield electrically connected to at least one of the upper shielding plate and the lower shielding plate.

2. The cable assembly as claimed in claim 1, wherein the ground shield is a shielding layer enclosing the insulative layer of the cable, and the shielding layer is in direct contact with the upper surface of the upper shielding plate.

3. The cable assembly as claimed in claim 2, wherein each of the upper and lower shielding plates is generally planar and is a single piece, and at least one of the upper shielding plate and the lower shielding plate integrally has a plurality of ground tails electrically connected to the ground shield.

4. The cable assembly as claimed in claim 3, wherein all the ground contact portions are formed on the upper shielding plate, and the ground tail is a sheet-like structure integrally formed on the lower shielding plate.

5. The cable assembly as claimed in claim 4, wherein the tail portions of the row of terminals extend backward beyond a rear end of the upper shielding plate, and the lower shielding plate extends backward beyond the tail portions of the row of terminals.

6. The cable assembly as claimed in claim 4, further comprising a shielding member having a receiving portion for receiving and contacting the shielding layer of the cable.

7. The cable assembly as claimed in claim 6, wherein the shielding member is arranged on the lower shielding plate and is in direct contact with the lower shielding plate.

8. The cable assembly as claimed in claim 7, wherein the shielding member includes an upper half and a lower half, each
of the upper half and the lower half comprises a raised portion and two straight portions connected to opposite sides of the raised portion, the raised portions of the upper half and lower half cooperate with each other to form the receiving portion that circumferentially surrounds and is electrically connected to exposed shielding layer of the cable.

9. The cable assembly as claimed in claim 8, wherein the straight portions of the upper half and the lower half have holes aligned with each other, and the ground tail extends upward into the holes.

10. The cable assembly as claimed in claim 4, wherein the upper shielding plate further comprises an overhanging feature for impedance control, the overhanging feature comprises plural front extensions each situated between every two ground contact portions, each of the front extensions is cantilevered above a corresponding pair of signal terminals, and the contact portions of the pair of signal terminals extend forward beyond frontmost ends of the front extensions.

11. The cable assembly as claimed in claim 1, further comprising a conductive element electrically connecting the upper and lower shielding plates, and the conductive element is made of conductive plastic and is integrally molded with the the upper shielding plate, the lower shielding plate, and the insulator.

12. The cable assembly as claimed in claim 11, wherein the insulator has a hole and the upper shielding plate and the lower shielding plate have holes aligned with the holes of the insulator, the conductive element is molded to enter the hole of the upper shielding plate, the hole of the insulator, and the hole of the lower shielding plate.

13. The cable assembly as claimed in claim 1, wherein the upper shielding plate and the lower shielding plate are equidistantly spaced from the row of terminals to form a strip-line structure.

14. The cable assembly as claimed in claim 1, wherein the row of terminals further includes plural sideband terminals, and the signal terminals are located on two sides of the sideband terminals.

15. A cable bypass assembly comprising:
a connector housing adapted for mating with a mating connector; and
a first cable assembly and a second cable assembly received in the connector housing and arranged symmetrically in an up-down direction, the first cable assembly comprising:
a first row of terminals arranged in a transverse direction perpendicular to the up-down direction, each of the first row of terminals having a plurality of contact portions and a plurality of tail portions, the first row of terminals comprising a plurality of pairs of first signal terminals for transmitting high-speed signals;
a first shielding plate disposed on one side of the first row of terminals and integrally having a plurality of first ground contact portions aligned with the plurality of contact portions of the first row of terminals; and
a plurality of first cables each including a pair of first signal conductors, a first insulative layer enclosing the pair of first signal conductors, and a first ground shield disposed outside the first insulative layer, the pair of first signal conductor terminated to the tail portions of a corresponding pair of first signal terminals, the first ground shield electrically connected to the first shielding plate.

16. The cable bypass assembly as claimed in claim 15, wherein the second cable assembly includes:
a second row of terminals arranged in the transverse direction and having a plurality of contact portions and a plurality of tail portions, the second row of terminals comprising a plurality of pairs of second signal terminals for transmitting high-speed signals;
a second shielding plate disposed on one side of the second row of terminals and integrally having a plurality of second ground contact portions aligned with the plurality of contact portions of the second row of terminals; and
a plurality of second cables each having a pair of second signal conductors, a second insulative layer enclosing the the pair of second signal conductors, and a second ground shield disposed outside the second insulative layer, the pair of second signal conductors terminated to the tail portions of a corresponding pair of second signal terminals, the second ground shield electrically connected to the second shielding plate.

17. The cable bypass assembly as claimed in claim 16, wherein the first cable assembly further includes a third shielding plate disposed on the other side of the first row of terminals, the second cable assembly further includes a fourth shielding plate disposed on the other side of the second row of terminals, and the first shielding plate, the second shielding plate, the third shielding plate, and the fourth shielding plate are electrically connected.

18. A cable bypass assembly adapted for mating with a mating connector that is inserted into a device for electrically connecting the mating connector to a vicinity of a chip of the device, the cable bypass assembly comprising:
a connector housing;
a first cable assembly received in the connector housing; and
a second cable assembly received in the connector housing and disposed opposite to the first cable assembly to form a mating area for mating with the mating connector, each of the first cable assembly and the second cable assembly including:
a plurality of pairs of signal terminals arranged in a row, each signal terminal including a signal contact portion and a signal tail portion;
an upper shielding plate disposed on an upper side of the row of signal terminals;
a lower shielding plate disposed on a lower side of the row of signal terminals, at least one of the upper shielding plate and the lower shielding plate integrally having a plurality of ground contact portions aligned with the signal contact portions of the plurality of pairs of signal terminals; and
a plurality of cables each comprising a pair of signal conductors, an insulative layer enclosing the pair of signal conductors, and a ground shield disposed outside the insulative layer, the ground shield and the signal conductors having opposed first and second free ends, the first free end of the signal conductors being electrically connected to the signal tail portions of a pairs of signal terminals, the first free end of the ground shield being electrically connected to at least one of the first shielding plate and the second shielding plate, and the second free ends of the ground shield and the signal conductors being electrically coupled to a vicinity of the chip within the device.

19. The cable bypass assembly as claimed in claim 18, wherein each of the first cable assembly and the second cable assembly further comprises a conductive element electrically connecting the upper and lower shielding plates, and the conductive element of the first cable assembly contact with the conductive element of the second cable assembly.

20. The cable bypass assembly as claimed in claim 18, further comprising a metal side plate for fixing the first cable assembly and the second cable assembly, and wherein the metal side plate has an elastic piece protruding outward for engaging a corresponding opening on the connector housing.
